(19) United States
(12) Patent Application Publication
(10) Pub. No.: US 2026/0059318 A1
(43) Pub. Date: Feb. 26, 2026

(54) COMMUNICATION RANGE CONTROL WITH SENSING ASSISTANCE

(71) Applicant: Apple Inc., Cupertino, CA (US)

(72) Inventors: Chunxuan Ye, San Diego, CA (US); Dawei Zhang, Saratoga, CA (US); Haijing Hu, Los Gatos, CA (US); Haitong Sun, Saratoga, CA (US); Huarui Liang, Beijing (CN); Oghenekome Oteri, San Diego, CA (US); Shu Guo, Beijing (CN); Wei Zeng, Saratoga, CA (US); Xiaoyu Qiao, Beijing (CN); Yingluo Luo, Beijing (CN)

(73) Assignee: Apple Inc., Cupertino, CA (US)

(21) Appl. No.: 19/246,655

(22) Filed: Jun. 23, 2025

Related U.S. Application Data
(60) Provisional application No. 63/686,688, filed on Aug. 23, 2024.

(51) Int. Cl. H04W 12/121; H04B 7/06; H04B 17/318; H04W 52/08; H04W 52/10; H04W 52/14; H04W 52/24

(52) U.S. Cl. CPC H04W 12/121; H04B 7/0626; H04B 17/318; H04W 52/08; H04W 52/10; H04W 52/143; H04W 52/242

(57) ABSTRACT

The present application relates to devices and components including apparatus, systems, and methods for sensing-assisted range control (e.g., transmission power control) for security.

### CROSS-REFERENCE TO RELATED APPLICATION

This application claims priority to U.S. Provisional Patent Application No. 63/686,688, entitled “COMMUNICATION RANGE CONTROL WITH SENSING ASSISTANCE,” filed on Aug. 23, 2024, which is herein incorporated by reference in its entirety for all purposes.

### TECHNICAL FIELD

This application relates generally to communication networks and, in particular, to communication range control with sensing assistance.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates a mono-static sensing model and a bi-static sensing model in accordance with some embodiments herein.

FIG. 3 illustrates an example procedure for sensing-assisted range control (e.g., transmission power control), in accordance with some embodiments.

FIG. 4 illustrates an example of sensing-assisted range control, in accordance with some embodiments.

FIG. 5 illustrates another example procedure for sensing-assisted range control, in accordance with some embodiments.

FIG. 6 illustrates an operational flow/algorithmic structure in accordance with some embodiments.

FIG. 7 illustrates another operational flow/algorithmic structure in accordance with some embodiments.

FIG. 8 illustrates a user equipment in accordance with some embodiments.

FIG. 9 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

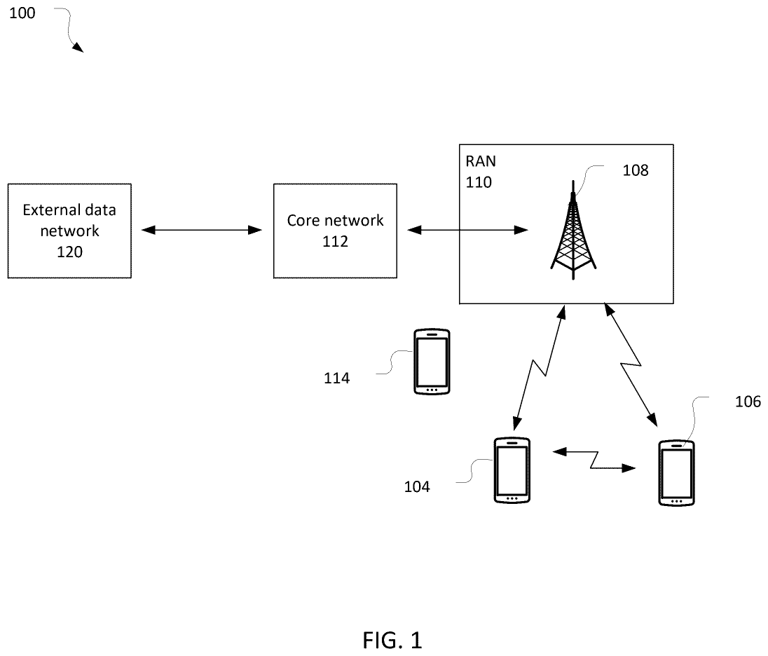

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP Technical Specifications (TSs) such as those that define a Fifth Generation (5G) new radio (NR) system or a later system. The base station 108 may provide user plane and control plane protocol terminations toward the UE 104. The UE 104 may connect with the RAN 110 to access an external data network 120.

In some embodiments, the base station 108 may correspond to a next generation NodeB (gNB). Additionally, or alternatively, the base station 108 may include one or more transmission-reception points (TRPs) to transmit and receive signals (e.g., signals to and from UE 104 and/or the sensing signals described herein).

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

In embodiments, the base station 108, UE 104, and/or UE 106 may perform sensing operations to detect and/or track objects in the environment. For example, the sensing operations may be in accordance with integrated sensing and communication (ISAC) protocols developed in 3GPP. The sensing operations may generally include transmitting a sensing signal, receiving the sensing signal, and processing the received sensing signal to generate sensing information (also referred to as sensing results) that indicates the presence and/or location of objects in the environment. Various sensing models have been developed, including mono-static sensing, in which the same device transmits and receives the sensing signal, and bi-static sensing, in which one device transmits the sensing signal and another device receives the sensing signal.

Various embodiments herein relate to using sensing information to improve security of communication. For example, the sensing information may be used to detect the presence and/or location information (e.g., direction, distance away, and/or coordinates) of an eavesdropper 114 (referred to herein as “Eve” 114). The location information (e.g., direction, distance away, and/or coordinates) of the UE 104 (referred to as the “target UE”) may also be determined based on the sensing information. Using the sensing information may enable more accurate determination of the location information of the UE 104 than prior techniques.

In various embodiments, the base station 108 and/or UE 104 may detect the presence of the Eve 114 based on the sensing information and may take one or more actions based on the detection. For example, the base station 108 and/or the UE 104 may determine a communication range (e.g., transmission power) for communication between the base station 108 and UE 104 based on the detection. In some embodiments, the transmission power for uplink and/or downlink transmissions may be reduced, e.g., to prevent or reduce the likelihood of the Eve 114 being able to receive the transmission.

In some embodiments in which the UE 104 detects the presence of the Eve 114, the UE 104 may transmit a message to the base station 108 to inform the base station 108 of the detected Eve 114. In some instances, the message may include the sensing information, e.g., to indicate the location information of the Eve 114. Additionally, or alternatively, the message may include a request to adjust the UL transmission power and/or the DL transmission power. In some instances, the message may include a suggested power setting for the UL transmission power and/or the DL transmission power.

In some embodiments, the transmission power may be reduced for a subset of uplink and/or downlink transmissions. For example, the transmission power may be reduced for a physical downlink shared channel (PDSCH), a physical downlink control channel (PDCCH), a demodulation reference signal (DMRS, e.g., used to facilitate decoding of the PDSCH and/or PDCCH), and/or channel state information (CSI)-reference signal (RS), while a higher transmission power may be maintained for one or more other transmissions, such as one or more of the above signals, one or more other RSs, and/or another suitable signal.

In other embodiments, or under some circumstances, the base station 108 and/or UE 104 may pause data transmission based on the sensing information. For example, the data transmission may be paused if the transmission or the UE 104 has a relatively high security level (e.g., at a threshold level or greater), and/or if it is determined that the transmission power cannot be reduced to a level that will avoid receipt by the Eve 114 while also enabling sufficient communication between the UE 104 and base station 108.

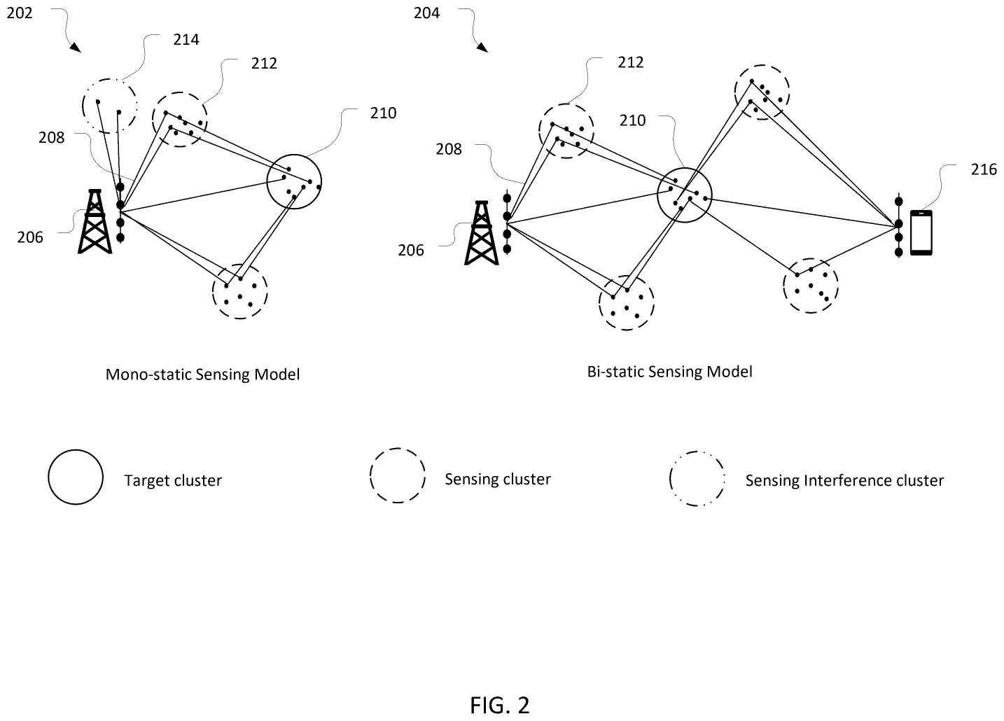

The techniques described herein may be used with any suitable sensing model, including mono-static sensing and bi-static sensing. For example, the techniques may be used with base station mono-static sensing, UE mono-static sensing, base station-UE bi-static sensing, UE-base station bi-static sensing, base station-base station bi-static sensing (including TRP-TRP bi-static sensing in which the TRPs are associated with the same base station), and UE-UE bi-static sensing. Example mono-static and bi-static sensing models are described further below with respect to FIG. 2.

While embodiments herein are described with reference to downlink transmissions from the base station 108 to the UE 104 and uplink transmissions from the UE 104 to the base station 108, aspects of various embodiments may be used for sidelink communication between the UE 104 and the UE 106.

In 3GPP release (Rel)-19, there is a study item of channel modelling for ISAC. Features related to ISAC may be adopted into future specifications, such as for 5G and/or 6G. Some objectives for 3GPP Rel-19 Integrated Sensing and Communications (ISAC) Study Item (SI) (see RP-234069) are described below.

The focus of the study is to define channel modelling aspects to support object detection and/or tracking (as per the SA1 meaning in 3GPP TS 22.137). The study should aim at a common modelling framework capable of detecting and/or tracking the following example objects and to enable them to be distinguished from unintended objects:
UAVs
Humans indoors and outdoors
Automotive vehicles (at least outdoors)
Automated guided vehicles (e.g. in indoor factories)
Objects creating hazards on roads/railways, with a minimum size dependent on frequency

All six sensing modes are considered (e.g. TRP-TRP bi-static, TRP monostatic, TRP-UE bi-static, UE-TRP bi-static, UE-UE bi-static, UE monostatic). Frequencies from 0.5 to 52.6 GHz are the primary focus, with the assumption that the modelling approach should scale to 100 GHz. (If significant problems are identified with scaling above 52.6 GHz, the range above 52.6 GHz can be deprioritized.) For the above use cases, sensing modes and frequencies, objectives include to:
Identify details of the deployment scenarios corresponding to the above use cases.
Define channel modelling details for sensing using 3GPP TS 38.901 as a starting point, and taking into account relevant measurements, including:
modelling of sensing targets and background environment, including, for example (if needed by the above use cases), radar cross-section (RCS), mobility and clutter/scattering patterns;
spatial consistency.

In the International Mobile Telecommunications (IMT)-2030 framework, the integration of sensing and communication is expected to become a key enabler for a wide range of use cases. Moreover, sensing the physical surroundings together with appropriate artificial intelligence (AI) could further enhance situational awareness.

FIG. 2 illustrates a mono-static sensing model 202 and a bi-static sensing model 204 in accordance with various embodiments herein. It is noted that the mono-static sensing model 202 is shown and described with reference to base station mono-static sensing. However, similar techniques may be used for UE mono-static sensing. Additionally, the bi-static sensing model 202 is shown and described with reference to base station-UE bi-static sensing. However, similar techniques may be used for other types of bi-static sensing.

As shown, in the mono-static sensing model 202, a base station 206 may transmit a sensing signal 208 into the surrounding environment. The environment may include a target cluster 210 that corresponds to an object that is to be detected, as well as sensing clusters 212 which correspond to other objects that are present in the environment. The environment may further include a sensing interference cluster 214 that corresponds to a source of interference. The base station 206 may receive the sensing signal 208 after it has reflected off the target cluster 210 (e.g., in some cases, via a sensing cluster 212). The base station 206 generates sensing information based on the received sensing signal 208. The sensing information may indicate the presence and/or location of the target cluster 210.

The bi-static sensing model 204 may involve a second device to receive the sensing signal, which in the model of base station-UE bi-static sensing shown in FIG. 2 is a UE 216. The base station 206 transmits a sensing signal 208. The UE 216 receives the sensing signal 208 after it has reflected off target cluster 210 (e.g., via a sensing cluster 212). The UE 208 generates sensing information based on the received sensing signal 208. The sensing information may indicate the presence and/or location of the target cluster 210.

Sensing-assisted communications such as ISAC may have impacts on security of the associated communications. For example, the transmission of the sensing signal may expose the communications signal to Eve. However, as disclosed herein, the sensing may also be used to enhance security of the communications, e.g., sensing-assisted PHY security. Secure ISAC transmission methods may address the conflicting objectives of illuminating signal energy to the radar target, while at the same time constraining the useful signal energy (e.g., signal-to-noise ratio (SNR)) towards the same direction of the sensed target, e.g., to inhibit its capability to eavesdrop the information signal sent to the communication users. The sensing capability can provide an enabling role for PHY security, where the sensing information (e.g., detected Eve's location, distance (such as indicated by a time of arrival (ToA)) and/or direction (such as indicated by angle of arrival (AoA)) may be used to enable sensing-assisted range control.

Some example techniques for sensing-assisted range control for security are described further below. For example, techniques are described for base station mono-static sensing, UE mono-static sensing, and bi-static sensing. It will be apparent that these techniques are provided as examples, and suitable modifications may be made in accordance with various embodiments.

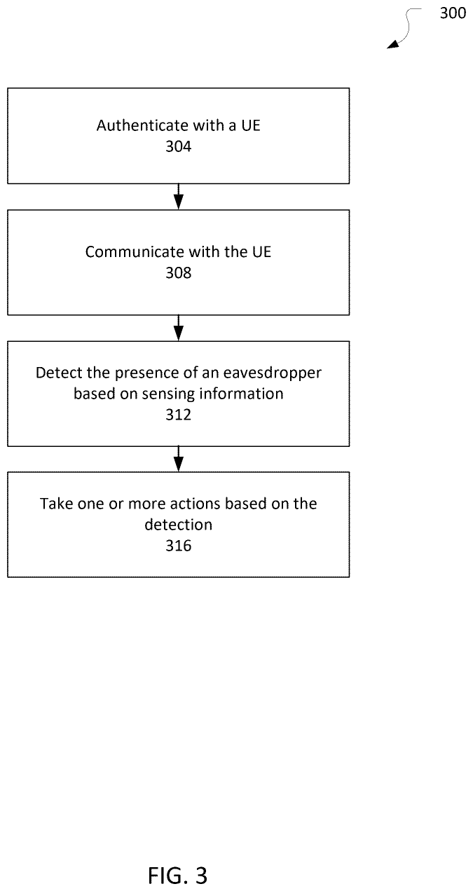

FIG. 3 illustrates an example procedure 300 in accordance with various embodiments. The procedure 300 may be performed by a base station (e.g., base station 108). Corresponding operations may be performed by a UE (e.g., UE 104).

At 304, the procedure 300 may include to authenticate with a UE (e.g., UE 104). The authentication may include configuring a security level associated with the UE and/or the communications between the UE and the base station. As discussed further below, the security level may be used to determine whether to take an action in response to detection of Eve and/or to determine the action to take in response to the detection.

At 308, the procedure 300 may include to communicate with the UE. For example, the base station may transmit DL signals to the UE using a first DL transmission power and/or receive UL signals from the UE that are transmitted by the UE with a first UL transmission power. In some embodiments, the first DL transmission power and/or the first UL transmission power may be configured by the base station.

At 312, the procedure 300 may include to detect the presence of an eavesdropper based on sensing information. The base station may detect that the eavesdropper is present in a communication range of the UE (e.g., a DL communication range based on the first DL transmission power and/or a UL communication range based on the first UL transmission power). For example, the base station may perform mono-static and/or bi-static sensing to obtain the sensing information. Additionally, or alternatively, the base station may receive the sensing information from the UE and/or another device (e.g., another UE and/or another base station).

At 316, the procedure 300 may include to take one or more actions based on the detection. In some embodiments, the one or more actions may be based on the QoS level of the communication between the base station and the UE and/or the security protocol between the UE and the base station. For example, an action may be taken for a QoS level and/or security protocol with a relatively high security level (e.g., a security level of a threshold level or greater). The security level may be associated with the UE and/or with a specific transmission (e.g., a data transmission).

In some embodiments, the base station may determine a second DL transmission power and/or a second UL transmission power for communication with the UE based on the detection of the eavesdropper. For example, the second DL transmission power and/or second UL transmission power may be less than the respective first DL transmission power or first UL transmission power. The respective transmission powers may correspond to a communication range of the corresponding transmission. The second DL transmission power and/or second UL transmission power may avoid and/or reduce the likelihood of receipt of the transmission by the Eve (also referred to as leakage to the Eve) while still enabling successful communication between the base station and the UE.

In other embodiments, the base station may pause one or more DL transmissions and/or UL transmissions (e.g., data transmission) based on the detection of the eavesdropper.

In some embodiments, the base station may later determine that the eavesdropper is no longer detected (e.g., no longer detected in the communication range of the UE based on the first DL transmission power and/or the first UL transmission power). The base station may take one or more actions based on the determination. For example, the base station may resume the one or more DL transmissions and/or UL transmissions that were paused. Additionally, or alternatively, the base station may adjust (e.g., increase) the DL transmission power and/or UL transmission power.

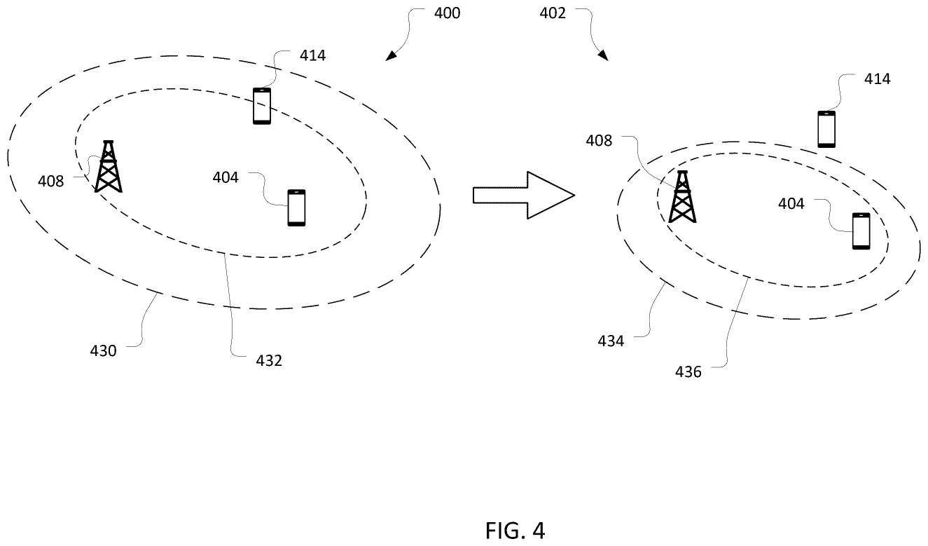

FIG. 4 illustrates an example of sensing-assisted transmission power control in accordance with various embodiments. As shown at 400, a base station 408 may transmit a DL transmission to a UE 404 with a first DL transmission power that corresponds to a first DL communication range 430. The UE 404 may transmit a UL transmission to the base station 408 with a first UL transmission power that corresponds to a first UL communication range 432. The base station 408 (and/or the UE 404, in some embodiments herein) may detect the presence of an Eve 414 in the first DL communication range 430 and/or the first UL communication range 432. The base station 408 may adjust the DL transmission power and/or UL transmission power based on the detection.

For example, as shown at 402 of FIG. 4, the base station 408 may adjust the DL transmission power to a second DL transmission power that corresponds to a second DL communication range 434. The base station 408 may adjust the UL transmission power to a second UL transmission power that corresponds to a second UL communication range 436. The Eve 414 may be outside of the second DL communication range 434 and/or second UL communication range, and thus unable to receive the respective DL transmission and/or UL transmission.

In some embodiments, the second DL transmission power may be used for transmission of a PDSCH, a DMRS (e.g., associated with the PDSCH), and/or a CSI-RS. In some instances, the adjustment of the DL transmission power from the first DL transmission power to the second DL transmission power may be transparent to the UE (e.g., the base station may not inform the UE of the change). For example, an adjustment of the transmission power for the PDSCH and/or DMRS may be transparent to the UE in some cases.

In other instances, the base station may send a message to the UE (e.g., via radio resource control (RRC) signaling) to configure the second DL transmission power. For example, the message may indicate a CSI-RS power control offset for the CSI-RS. The CSI-RS power control offset may be, for example, the powerControlOffsetSS parameter in the information element (IE) for a non-zero power (NZP) CSI-RS resource (“NZP-CSI-RS Resource”) defined in 3GPP TS 38.331. The powerControlOffsetSS may indicate the offset of the CSI-RS transmit power with reference to the transmit power of a secondary synchronization signal (SSS). The SSS may have a fixed transmission power. In the existing TS 38.331, the possible values of the powerControlOffsetSS are {−3, 0, 3, 6} decibels (dBs). A positive offset value indicates that the transmission power of the CSI-RS will be less than the transmission power of the SSS by the amount of the offset (e.g., a 3 dB offset indicates that the transmission power of the CSI-RS is 3 dB less than the transmission power of the SSS), while a negative offset value indicates that the transmission power of the CSI-RS will be greater than the transmission power of the SSS by indicated amount (e.g., a-3 dB offset indicates that the transmission power of the CSI-RS is 3 dB greater than the transmission power of the SSS).

In some embodiments, the definition of the powerControlOffsetSS may be updated to have a greater range of values and/or a smaller granularity than the existing definition. For example, the range of values may include offset values greater than 6 dB (indicating a greater than 6 dB power reduction for the CSI-RS from the transmission power of the SSS), such as a value range of [−5:10] dB. The smaller granularity may include a step size of less than 3 dB between successive values, such as a step size of 1 dB or 2 dB.

In other embodiments, a new parameter may be defined to indicate the CSI-RS power control offset of the CSI-RS for sensing-assisted power control (e.g., referred to as “powerControlOffsetSS_sensing”). For example, the new parameter may be included in the IE of the NZP CSI-RS resource. The new parameter may be applied in conjunction with the existing powerControlOffsetSS, e.g., to indicate an additional power adjustment (such as a power reduction) on top of the adjustment indicated by the powerControlOffsetSS parameter. In some embodiments, the new parameter may have a finer granularity (e.g., 1 dB or 2 dB) than the powerControlOffsetSS parameter.

In some embodiments, the base station may indicate a PDSCH power control offset for the PDSCH to the UE. The PDSCH power control offset may be indicated via RRC, such as in the same message as the indication of the CSI-RS power control offset. The PDSCH power control offset may be, for example, the powerControlOffset parameter in the NZP-CSI-RS Resource IE defined in 3GPP TS 38.331. The powerControlOffset may indicate the offset of the PDSCH transmission power with reference to the transmission power of the CSI-RS. In the existing TS 38.331, the range of values of the powerControlOffset is [−8:15]. Similar to the CSI-RS power control offset discussed above, a value of the powerControlOffset indicates that the transmission power of the PDSCH will be less than the transmission power of the CSI-RS by the amount of the offset (e.g., a 3 dB offset indicates that the transmission power of the PDSCH is 3 dB less than the transmission power of the CSI-RS), while a negative offset value indicates that the transmission power of the PDSCH will be greater than the transmission power of the CSI-RS by indicated amount (e.g., a-3 dB offset indicates that the transmission power of the PDSCH is 3 dB greater than the transmission power of the CSI-RS).

In some embodiments, the definition of the powerControlOffset for the PDSCH may be updated to have a greater range of values and/or a smaller granularity than the existing definition. For example, the range of values may include one or more offset values greater than 15 dB (indicating a greater than 6 dB power reduction for the PDSCH from the transmission power of the CSI-RS), such as a value range of [−10:20] dB.

In other embodiments, a new parameter may be defined to indicate the PDSCH power control offset of the PDSCH for sensing-assisted power control (e.g., referred to as “powerControlOffset_sensing”). For example, the new parameter may be included in the IE of the NZP CSI-RS resource. The new parameter may be applied in conjunction with the existing powerControlOffset, e.g., to indicate an additional power adjustment (such as a power reduction) on top of the adjustment indicated by the powerControlOffset parameter. In some embodiments, the new parameter may have a finer granularity than the powerControlOffset parameter.

In some embodiments, the base station may indicate a DMRS power scaling factor to the UE that corresponds to the transmission power of the DMRS. The DMRS power scaling factor may be, for example, the existing

$${β}_{PDSCH}^{DMRS}$$

parameter. Alternatively, a new DMRS power scaling factor may be introduced for DMRS power scaling for based on sensing information. The new DMRS power scaling factor may be applied independently of the existing

$${β}_{PDSCH}^{DMRS}$$

parameter or in conjunction with the

$${β}_{PDSCH}^{DMRS}$$

parameter.

In various embodiments, the base station may adjust the UL transmission power (e.g., to the second UL transmission power) using a closed loop power control procedure and/or an open loop power control procedure. For example, in accordance with the closed loop power control procedure, the base station may transmit a transmit power control (TPC) command to the UE. The UE may determine the UL transmission power to use based on the TPC command. For example, the TPC command may indicate an accumulated power value and/or an absolute power value.

In one example, the TPC command may be included in a downlink control information (DCI). In some embodiments, the value range of the TPC command may be increased from the current value range, e.g., as indicated in Table 7.1.1-1 of 3GPP TS 38.213. For example, Table 7.1.1-1 may be updated to include additional accumulated power values and/or absolute power values. In some embodiments, the TPC command field in the DCI may include additional bits to indicate a respective entry of the updated Table 7.1.1-1.

In another example, the TPC command may be included in a medium access control-control element (MAC-CE) transmitted by the base station to the UE. The MAC-CE may be newly defined to indicate the TPC command, e.g., for sensing-assisted power control.

In other embodiments, the base station may adjust the UL transmission power based on an indicated pathloss offset for a pathloss calculation, e.g., associated with the open loop power control procedure. For example, the base station may configure a pathloss offset for the UE, e.g., via RRC. The base station may send the UE a message, e.g., a MAC CE, to indicate an additional offset to be applied in conjunction with the configured pathloss offset. In other embodiments, the base station may configure the UE with multiple pathloss offset values, e.g., via RRC. The base station may send a message, e.g., a MAC CE, to activate one of the configured pathloss offset values. In other embodiments, the base station may transmit a MAC CE that directly indicates the pathloss offset for the UE to use.

The UE may determine the UL transmission power to apply based on the pathloss offset indicated by the base station (e.g., with the additional offset, if applicable).

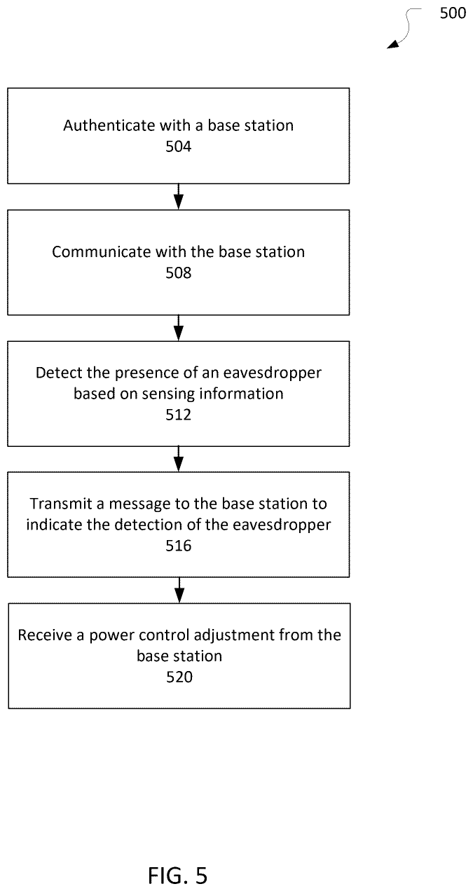

FIG. 5 illustrates another example procedure 500 in accordance with some embodiments. The procedure 500 may be performed by a UE (e.g., UE 104). Corresponding operations of the procedure 500 may be performed by a base station (e.g., base station 108). In the procedure 500, the UE may detect the presence of the Eve and inform the base station. In some embodiments, the UE may indicate a recommended power adjustment to the base station.

At 504, the procedure 500 may include to authenticate with a base station. The authentication may include configuring a security level associated with the UE and/or communications between the UE and the base station. As discussed further below, the security level may be used to determine whether to take an action in response to detection of Eve and/or to determine the action to take in response to the detection.

At 508, the procedure 500 may include to communicate with the base station. For example, the UE may receive DL signals from the base station that are transmitted with a first DL transmission power and/or transmit UL signals to the base station with a first UL transmission power. In some embodiments, the first DL transmission power and/or the first UL transmission power may be configured by the base station.

At 512, the procedure 500 may include to detect the presence of an eavesdropper based on sensing information. For example, the UE may perform mono-static sensing and/or bi-static sensing to obtain the sensing information.

At 516, the procedure 500 may include to transmit a message to the base station to indicate the detection of the eavesdropper. The message may be, for example, a RRC message and/or a MAC CE. In some embodiments, the UE may determine a recommended power adjustment for DL transmission and/or UL transmission and indicate the recommended power adjustment to the base station (e.g., in the RRC message and/or the MAC CE). The recommended power adjustment may be an absolute power value or an offset value with reference to the current DL or UL transmission power. In some embodiments, the UE may indicate a latency requirement for the power adjustment (e.g., to indicate how quickly and/or when the UE requests the power adjustment to be made). In other embodiments, the UE may send the sensing information to the base station, and the network may determine the power adjustment to apply based on the sensing information.

At 520, the procedure 500 may include to receive a power control adjustment from the base station (e.g., based on the indicated detection). The power control adjustment may indicate an adjustment to the DL transmission power and/or UL transmission power of one or more transmissions. For example, the power control adjustment may include a CSI-RS power control offset, a PDSCH power control offset, a DMRS scaling factor, a TPC command, and/or a pathloss offset.

In some embodiments, the UE may later determine that the eavesdropper is no longer detected (e.g., no longer detected in the communication range of the UE). The UE may send a message to the base station to notify the base station of the determination. In some embodiments, the message may include an updated recommended power adjustment. The UE may receive an updated power control adjustment from the base station based on the notification that the eavesdropper is no longer detected.

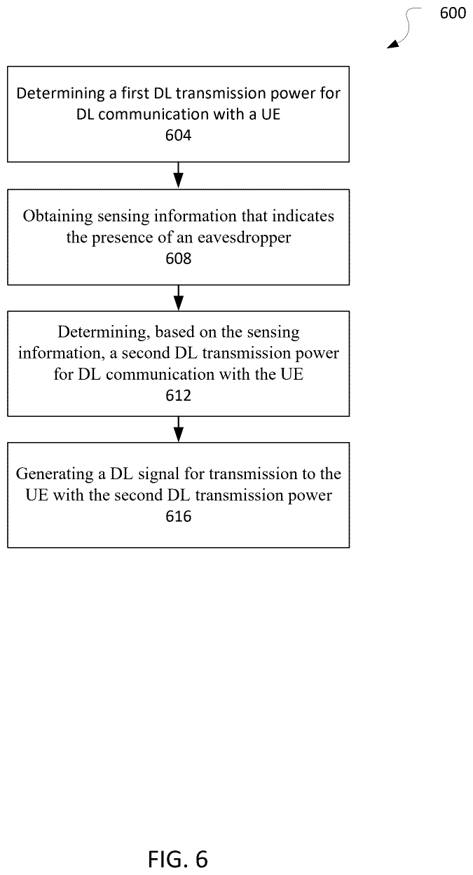

FIG. 6 is an operational flow/algorithmic structure 600 in accordance with some embodiments. The operational flow/algorithmic structure 600 may be performed by a base station, such as base station 108, network device 900, or components thereof, for example, processors 904A.

The operational flow/algorithmic structure 600 may include, at 604, determining a first DL transmission power for DL communication with a UE.

The operational flow/algorithmic structure 600 may further include, at 608, obtaining sensing information that indicates the presence of an eavesdropper. For example, the base station may perform mono-static and/or bi-static sensing to obtain the sensing information. Additionally, or alternatively, the base station may receive the sensing information from the UE.

The operational flow/algorithmic structure 600 may further include, at 612, determining, based on the sensing information, a second DL transmission power for DL communication with the UE. In some embodiments, the second DL transmission power may be less than the first DL transmission power. In some instances, the second DL transmission power may be determined based on a security level of the UE. For example, the DL transmission power may be changed for a relatively high security level (e.g., a threshold level or greater).

The operational flow/algorithmic structure 600 may further include, at 616, generating a DL signal for transmission to the UE with the second DL transmission power. The DL signal may be, for example, a PDSCH, a DMRS, a CSI-RS, and/or another DL signal.

In some embodiments, the base station may indicate the second DL transmission power to the UE. For example, the base station may indicate a CSI-RS power control offset, a PDSCH power control offset, and/or a DMRS scaling factor to the UE.

In some embodiments, the base station may determine a UL transmission power for UL communication with the UE based on the sensing information. The base station may indicate the determined UL transmission power to the UE. For example, the base station may indicate a TPC command and/or a pathloss offset to the UE.

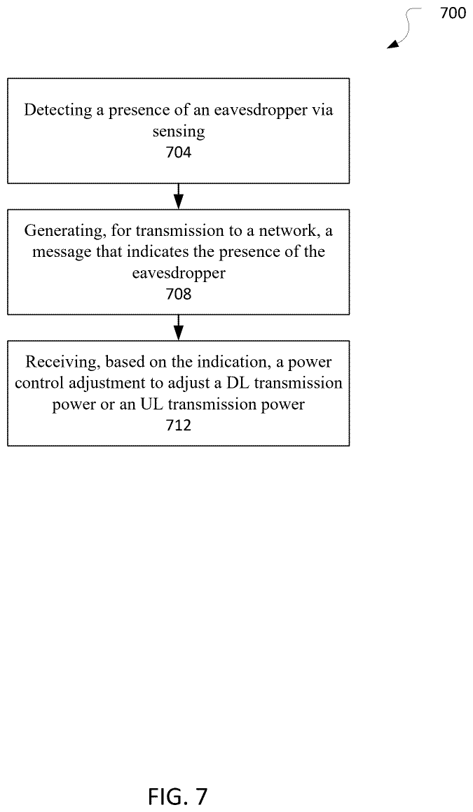

FIG. 7 is an operational flow/algorithmic structure 700 for sensing-assisted beamforming in accordance with some embodiments. The operational flow/algorithmic structure 900 may be implemented by a UE such as, for example, UE 104, UE 800, or components thereof; for example, a baseband processor 804A.

The operational flow/algorithmic structure 700 may include, at 704, detecting a presence of an eavesdropper via sensing. The sensing may include, for example, UE mono-static sensing or bi-static sensing (e.g., base station-UE bi-static sensing and/or UE-UE bi-static sensing).

The operational flow/algorithmic structure 700 may further include, at 708, generating, for transmission to a network, a message that indicates the presence of the eavesdropper. In some embodiments, the message may further include a UE recommendation for a power control adjustment to be made based on the detected eavesdropper. In some instances, the message may be transmitted based on a security level of the UE. For example, the UE may send the message if the security level is at a threshold level or greater.

The operational flow/algorithmic structure 700 may further include, at 712, receiving, based on the indication, a power control adjustment to adjust a DL transmission power or an UL transmission power. For example, the power control adjustment may include a CSI-RS power control offset, a PDSCH power control offset, a DMRS scaling factor, a TPC command, and/or a pathloss offset.

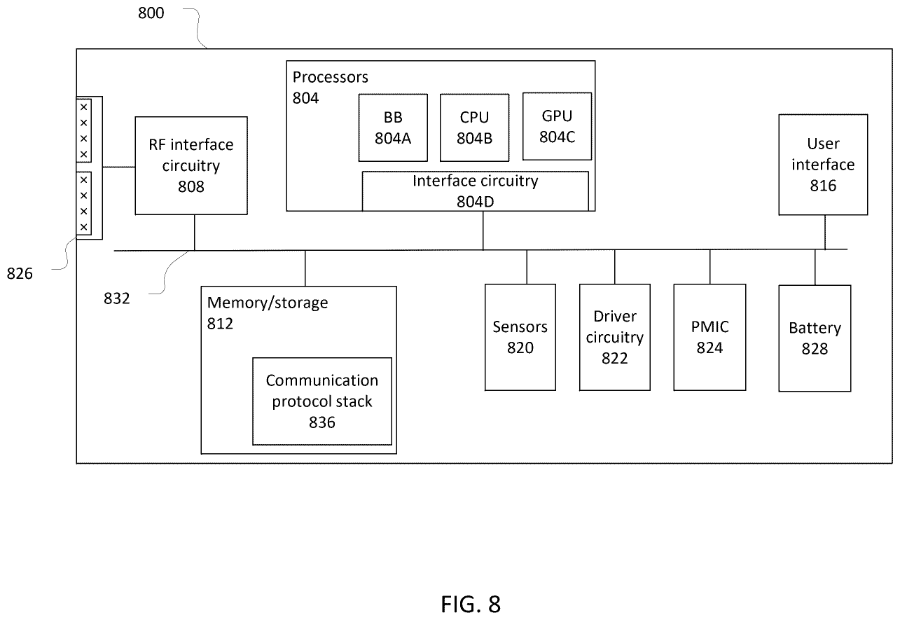

FIG. 8 illustrates a UE 800 in accordance with some embodiments. The UE 800 may be similar to and substantially interchangeable with UE 104.

The UE 800 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 800 may include processors 804, RF interface circuitry 808, memory/storage 812, user interface 816, sensors 820, driver circuitry 822, power management integrated circuit (PMIC) 824, antenna 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein (e.g., operations associated with sensing-assisted range control). The processors 804 may also include interface circuitry 804D to enable communication by, for example, communicatively coupling the processor circuitry with one or more other components of the UE 800.

In some embodiments, the baseband processor 804A may access a communication protocol stack 836 in the memory/storage 812 to communicate over a 3GPP compatible network. In general, the baseband processor 804A may access the communication protocol stack 836 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 808.

The baseband processor 804A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 812 may include one or more non-transitory, computer-readable media that includes instructions (for example, communication protocol stack 836) that may be executed by one or more of the processors 804 to cause the UE 800 to perform operations as described herein (e.g., operations associated with sensing-assisted range control).

The memory/storage 812 includes any type of volatile or non-volatile memory that may be distributed throughout the UE 800. In some embodiments, some of the memory/storage 812 may be located on the processors 804 themselves (for example, memory/storage 812 may be part of a chipset that corresponds to the baseband processor 804A), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and a radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, or phased array antennas. The antenna 826 may have one or more panels designed for specific frequency bands including bands in FR1 or FR2.

The user interface 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensors 820 and control and allow access to sensors 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

A battery 828 may power the UE 800, although in some examples the UE 800 may be mounted deployed in a fixed location and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

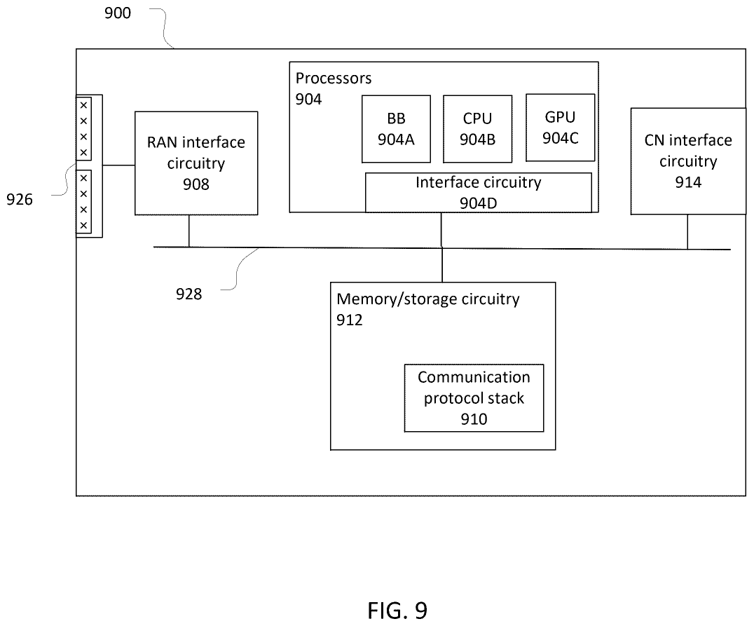

FIG. 9 illustrates a network device 900 in accordance with some embodiments. The network device 900 may be similar to, and substantially interchangeable with, the base station 108 and/or a component of the CN 112.

The network device 900 may include processors 904, RF interface circuitry 908 (if implemented as a base station), core network (CN) interface circuitry 914, memory/storage circuitry 912, and antenna structure 926.

The components of the network device 900 may be coupled with various other components over one or more interconnects 928.

The processors 904, RF interface circuitry 908, memory/storage circuitry 912 (including communication protocol stack 910), antenna structure 926, and interconnects 928 may be similar to like-named elements shown and described with respect to FIG. 8.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage circuitry 912 to cause the network device 900 to perform operations as described herein (e.g., operations associated with sensing-assisted beamforming). The processors 904 may also include interface circuitry 904D to communicatively couple the processor circuitry with one or more other components of the network device 900.

The CN interface circuitry 914 may provide connectivity to a core network, for example, a 5th Generation Core network (5GC) using a 5GC-compatible network interface protocol such as carrier Ethernet protocols, or some other suitable protocol. Network connectivity may be provided to/from the network device 900 via a fiber optic or wireless backhaul. The CN interface circuitry 914 may include one or more dedicated processors or FPGAs to communicate using one or more of the aforementioned protocols. In some implementations, the CN interface circuitry 914 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method comprising: determining a first downlink (DL) transmission power for DL communication with a user equipment (UE); obtaining sensing information that indicates a presence of an eavesdropper; determining, based on the sensing information and a security level associated with the UE, a second DL transmission power for DL communication with the UE, wherein the second DL transmission power is less than the first DL transmission power; and generating a DL signal for transmission to the UE with the second DL transmission power.

Example 2 may include the method of example 1 or some other example herein, further comprising generating, for transmission to the UE, a message to indicate the second DL transmission power.

Example 3 may include the method of example 2 or some other example herein, wherein the message indicates a channel state information (CSI)-reference signal (RS) power control offset to be applied to a CSI-RS.

Example 4 may include the method of example 3 or some other example herein, wherein the CSI-RS power control offset indicates a power offset of the CSI-RS with reference to a synchronization signal, and wherein the CSI-RS power control offset has a value of greater than 6 decibels (dB) or the indication has a step size of less than 3 dB.

Example 5 may include the method of example 3 or some other example herein, wherein the CSI-RS power control offset is an additional CSI-RS power control offset for sensing-assisted power control that is to be applied on top of a first CSI-RS power control offset with respect to a synchronization signal.

Example 6 may include the method of example 1 or some other example herein, wherein the message indicates a physical downlink shared channel (PDSCH) power control offset to be applied to a PDSCH.

Example 7 may include the method of example 6 or some other example herein, wherein the PDSCH power control offset indicates a power offset of the PDSCH with reference to a channel state information (CSI)-reference signal (RS), and wherein the PDSCH power control offset has a value of greater than 15 decibels (dB).

Example 8 may include the method of example 6 or some other example herein, wherein the PDSCH power control offset is an additional PDSCH power control offset for sensing-assisted power control that is to be applied on top of a first PDSCH power control offset with respect to a channel state information (CSI)-reference signal (RS).

Example 9 may include the method of example 1 or some other example herein, wherein the message indicates a demodulation reference signal (DMRS) scaling factor.

Example 10 may include the method of example 1 or some other example herein, wherein the second DL transmission power applies to a subset of DL transmissions to the UE.

Example 11 may include the method of example 1 or some other example herein, wherein the security level corresponds to a security profile between the UE and a network.

Example 12 may include the method of example 1 or some other example herein, further comprising: determining a first uplink (UL) transmission power for UL communication with the UE; determining, based on the sensing information and the security level associated with the UE, a second UL transmission power for UL communication with the UE, wherein the second UL transmission power is less than the first UL transmission power; and generating, for transmission to the UE, a message to indicate the second UL transmission power.

Example 13 may include the method of example 12 or some other example herein, wherein the message indicates a transmission power control (TPC) command for closed loop power control.

Example 14 may include the method of example 13 or some other example herein, wherein the message is a radio resource control (RRC) message or a medium access control-control element (MAC-CE).

Example 15 may include the method of example 12 or some other example herein, wherein the message indicates a pathloss offset for open loop power control.

Example 16 may include the method of example 15 or some other example herein, wherein the message indicates an additional pathloss offset to be applied on top of a pathloss offset configured via radio resource control (RRC) signaling.

Example 17 may include the method of example 15 or some other example herein, wherein the pathloss offset is a first pathloss offset, and wherein the method further comprises: receiving a configuration of multiple pathloss offsets, including the first pathloss offset, wherein the message indicates the first pathloss offset from among the multiple pathloss offsets.

Example 18 may include the method of example 15 or some other example herein, wherein the message is a radio resource control (RRC) message or a medium access control-control element (MAC-CE).

Example 19 may include a method comprising: detecting a presence of an eavesdropper via sensing; generating, for transmission to a network based on a security level associated with a user equipment (UE), a message that indicates the presence of the eavesdropper; and receiving, based on the indication, a power control adjustment to adjust a downlink (DL) transmission power or an uplink (UL) transmission power.

Example 20 may include the method of example 19 or some other example herein, further comprising determining a recommended value for the power control adjustment based on sensing information associated with the eavesdropper, wherein the message further includes the recommended value.

Example 21 may include the method of example 20 or some other example herein, wherein the sensing information includes user equipment (UE) mono-static or bi-static sensing information.

Example 22 may include the method of example 19 or some other example herein, wherein the power control adjustment includes a channel state information (CSI)-reference signal (RS) power control offset to be applied to a CSI-RS.

Example 23 may include the method of example 22 or some other example herein, wherein the CSI-RS power control offset indicates a power offset of the CSI-RS with reference to a synchronization signal, and wherein the CSI-RS power control offset has a value of greater than 6 decibels (dB) or is indicated from among a set of values with a step size of less than 3 dB.

Example 24 may include the method of example 22 or some other example herein, wherein the CSI-RS power control offset is an additional CSI-RS power control offset for sensing-assisted power control that is to be applied on top of a first CSI-RS power control offset with respect to a synchronization signal.

Example 25 may include the method of example 19 or some other example herein, wherein the power control adjustment includes a physical downlink shared channel (PDSCH) power control offset to be applied to a PDSCH.

Example 26 may include the method of example 25 or some other example herein, wherein the PDSCH power control offset indicates a power offset of the PDSCH with reference to a channel state information (CSI)-reference signal (RS), and wherein the PDSCH power control offset has a value of greater than 15 decibels (dB).

Example 27 may include the method of example 25 or some other example herein, wherein the PDSCH power control offset is an additional PDSCH power control offset for sensing-assisted power control that is to be applied on top of a first PDSCH power control offset with respect to a channel state information (CSI)-reference signal (RS).

Example 28 may include the method of example 19 or some other example herein, wherein the power control adjustment includes a demodulation reference signal (DMRS) scaling factor.

Example 29 may include the method of example 19 or some other example herein, wherein the power control adjustment applies to a subset of DL transmissions to a user equipment (UE).

Example 30 may include the method of example 19 or some other example herein, wherein the security level corresponds to a security profile between the UE and a network.

Example 31 may include the method of example 19 or some other example herein, wherein the power control adjustment is to adjust the UL transmission power, and wherein the method further comprises generating a UL signal for transmission with the adjusted UL transmission power.

Example 32 may include the method of example 19 or some other example herein, wherein the power control adjustment includes a transmission power control (TPC) command for closed loop power control.

Example 33 may include the method of example 32 or some other example herein, wherein the TPC command is received in a radio resource control (RRC) message or a medium access control-control element (MAC-CE).

Example 34 may include the method of example 19 or some other example herein, wherein the power control adjustment includes a pathloss offset for open loop power control.

Example 35 may include the method of example 34 or some other example herein, wherein the pathloss offset includes an additional pathloss offset to be applied on top of a first pathloss offset configured via radio resource control (RRC) signaling.

Example 36 may include the method of example 34 or some other example herein, wherein the pathloss offset is a first pathloss offset, and wherein the method further comprises receiving a configuration of multiple pathloss offsets, including the first pathloss offset, wherein receiving the power control adjustment includes receiving an indication of the first pathloss offset from among the multiple pathloss offsets.

Example 37 may include the method of example 34 or some other example herein, wherein the pathloss offset is included in a radio resource control (RRC) message or a medium access control-control element (MAC-CE).

Example 38 may include an apparatus comprising processor circuitry to: obtain sensing information that indicates a presence of an eavesdropper in a communication range associated with a user equipment (UE); and encode, based on the sensing information, a message for transmission to the UE that indicates a power control adjustment to adjust a downlink (DL) transmission power or an uplink (UL) transmission power for communication with the UE. The apparatus further comprises interface circuitry coupled with the processor circuitry, the interface circuitry to communicatively couple the processor circuitry to a component of a device.

Example 39 may include the apparatus of example 38 or some other example herein, wherein the power control adjustment includes a channel state information (CSI)-reference signal (RS) power control offset to be applied to a CSI-RS.

Example 40 may include the apparatus of example 38 or some other example herein, wherein the power control adjustment includes a physical downlink shared channel (PDSCH) power control offset to be applied to a PDSCH.

Example 41 may include the apparatus of example 38 or some other example herein, wherein the power control adjustment includes a demodulation reference signal (DMRS) scaling factor.

Example 42 may include the apparatus of example 38 or some other example herein, wherein the power control adjustment includes a transmission power control (TPC) command for closed loop power control.

Example 43 may include the apparatus of example 38 or some other example herein, wherein the power control adjustment includes a pathloss offset for open loop power control.

Example 44 may include the apparatus of example 38 or some other example herein, wherein the power control adjustment applies to a subset of DL transmissions to the UE or a subset of UL transmissions from the UE.

Example 45 may include the apparatus of example 38 or some other example herein, wherein the power control adjustment is based on a security profile associated with the UE.

Example 46 may include the apparatus of example 38 or some other example herein, wherein the sensing information is received from the UE, and wherein the processor circuitry is further to receive, from the UE, a UE recommendation for the power control adjustment.

Another example may include an apparatus comprising means to perform one or more elements of a method described in or related to any of examples 1-46, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-46, or any other method or process described herein.

Another example may include an apparatus comprising logic, modules, or circuitry to perform one or more elements of a method described in or related to any of examples 1-46, or any other method or process described herein.

Another example may include a method, technique, or process as described in or related to any of examples 1-46, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-46, or portions thereof.

Another example may include a signal as described in or related to any of examples 1-46, or portions or parts thereof.

Another example may include a datagram, information element, packet, frame, segment, PDU, or message as described in or related to any of examples 1-46, or portions or parts thereof, or otherwise described in the present disclosure.

Another example may include a signal encoded with data as described in or related to any of examples 1-46, or portions or parts thereof, or otherwise described in the present disclosure.

Another example may include a signal encoded with a datagram, IE, packet, frame, segment, PDU, or message as described in or related to any of examples 1-46, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-46, or portions thereof.

Another example may include a computer program comprising instructions, wherein execution of the program by a processing element is to cause the processing element to carry out the method, techniques, or process as described in or related to any of examples 1-46, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated.

What is claimed is:

1. A method comprising:
determining a first downlink (DL) transmission power for DL communication with a user equipment (UE);
obtaining sensing information that indicates a presence of an eavesdropper;
determining, based on the sensing information and a security level associated with the UE, a second DL transmission power for DL communication with the UE, wherein the second DL transmission power is less than the first DL transmission power; and
generating a DL signal for transmission to the UE with the second DL transmission power.

2. The method of claim 1, further comprising:
generating, for transmission to the UE, a message to indicate the second DL transmission power.

3. The method of claim 2, wherein the message indicates a channel state information (CSI)-reference signal (RS) power control offset to be applied to a CSI-RS, and wherein:
the CSI-RS power control offset indicates a power offset of the CSI-RS with reference to a synchronization signal, and wherein the CSI-RS power control offset has a value of greater than 6 decibels (dB) or the indication has a step size of less than 3 dB; or
the CSI-RS power control offset is an additional CSI-RS power control offset for sensing-assisted power control that is to be applied on top of a first CSI-RS power control offset with respect to a synchronization signal.

4. The method of claim 1, wherein the message indicates a physical downlink shared channel (PDSCH) power control offset to be applied to a PDSCH, and wherein:
the PDSCH power control offset indicates a power offset of the PDSCH with reference to a channel state information (CSI)-reference signal (RS), and wherein the PDSCH power control offset has a value of greater than 15 decibels (dB); or
the PDSCH power control offset is an additional PDSCH power control offset for sensing-assisted power control that is to be applied on top of a first PDSCH power control offset with respect to a channel state information (CSI)-reference signal (RS).

5. The method of claim 1, wherein the message indicates a demodulation reference signal (DMRS) scaling factor.

6. The method of claim 1, wherein the second DL transmission power applies to a subset of DL transmissions to the UE; or
wherein the security level corresponds to a security profile between the UE and a network.

7. The method of claim 1, further comprising:
determining a first uplink (UL) transmission power for UL communication with the UE;
determining, based on the sensing information and the security level associated with the UE, a second UL transmission power for UL communication with the UE, wherein the second UL transmission power is less than the first UL transmission power; and
generating, for transmission to the UE, a message to indicate the second UL transmission power.

8. The method of claim 7, wherein the message indicates a transmission power control (TPC) command for closed loop power control; or
wherein the message indicates a pathloss offset for open loop power control.

9. The method of claim 7, wherein the message indicates the pathloss offset for open loop power control, wherein the pathloss offset is a first pathloss offset, and wherein:
the first pathloss offset is an additional pathloss offset to be applied on top of a second pathloss offset configured via radio resource control (RRC) signaling; or
the method further comprises receiving a configuration of multiple pathloss offsets, including the first pathloss offset, wherein the message indicates the first pathloss offset from among the multiple pathloss offsets.

10. The method of claim 7, wherein the message is a radio resource control (RRC) message or a medium access control—control element (MAC-CE).

11. A method comprising:
detecting a presence of an eavesdropper via sensing;
generating, for transmission to a network based on a security level associated with a user equipment (UE), a message that indicates the presence of the eavesdropper; and
receiving, based on the indication, a power control adjustment to adjust a downlink (DL) transmission power or an uplink (UL) transmission power.

12. The method of claim 11, further comprising determining a recommended value for the power control adjustment based on sensing information associated with the eavesdropper, wherein the message further includes the recommended value.

13. The method of claim 11, wherein the power control adjustment includes a channel state information (CSI)-reference signal (RS) power control offset to be applied to a CSI-RS, a physical downlink shared channel (PDSCH) power control offset to be applied to a PDSCH, or a demodulation reference signal (DMRS) scaling factor.

14. The method of claim 13, wherein:
the power control adjustment includes the CSI-RS power control offset and:
the CSI-RS power control offset indicates a power offset of the CSI-RS with reference to a synchronization signal, and wherein the CSI-RS power control offset has a value of greater than 6 decibels (dB) or is indicated from among a set of values with a step size of less than 3 dB; or
the CSI-RS power control offset is an additional CSI-RS power control offset for sensing-assisted power control that is to be applied on top of a first CSI-RS power control offset with respect to a synchronization signal; or
the power control adjustment includes the PDSCH power control offset and:
the PDSCH power control offset indicates a power offset of the PDSCH with reference to a channel state information (CSI)-reference signal (RS), and wherein the PDSCH power control offset has a value of greater than 15 decibels (dB); or
the PDSCH power control offset is an additional PDSCH power control offset for sensing-assisted power control that is to be applied on top of a first PDSCH power control offset with respect to a channel state information (CSI)-reference signal (RS).

15. The method of claim 11, wherein the power control adjustment applies to a subset of DL transmissions to a user equipment (UE).

16. The method of claim 11, wherein the power control adjustment is to adjust the UL transmission power, wherein the power control adjustment includes a transmission power control (TPC) command for closed loop power control or a pathloss offset for open loop power control, and wherein the method further comprises generating a UL signal for transmission based on the power control adjustment.

17. An apparatus comprising:
processor circuitry to:
obtain sensing information that indicates a presence of an eavesdropper in a communication range associated with a user equipment (UE); and
encode, based on the sensing information, a message for transmission to the UE that indicates a power control adjustment to adjust a downlink (DL) transmission power or an uplink (UL) transmission power for communication with the UE; and
interface circuitry coupled with the processor circuitry to enable communication.

18. The apparatus of claim 17, wherein the power control adjustment is to adjust the DL transmission power and wherein the power control adjustment includes a channel state information (CSI)-reference signal (RS) power control offset to be applied to a CSI-RS, a physical downlink shared channel (PDSCH) power control offset to be applied to a PDSCH, or a demodulation reference signal (DMRS) scaling factor.

19. The apparatus of claim 17, wherein the power control adjustment is to adjust the UL transmission power and wherein the power control adjustment includes a transmission power control (TPC) command for closed loop power control or a pathloss offset for open loop power control.

20. The apparatus of claim 17, wherein:
the power control adjustment applies to a subset of DL transmissions to the UE or a subset of UL transmissions from the UE;
the power control adjustment is based on a security profile associated with the UE; or
the sensing information is received from the UE, and wherein the processor circuitry is further to receive, from the UE, a UE recommendation for the power control adjustment.
